(19) United States
(12) Patent Application Publication
(10) Pub. No.: US 2016/0008673 A1
(43) Pub. Date: Jan. 14, 2016

(54) Manufacturing Method For Baseball And Softball

(71) Applicants: Chi-Ching Lin, Taipei City (TW); Hsien-Chang Wu, Taipei City (TW); Hung-Sung Hsu, Taipei City (TW)

(72) Inventors: Chi-Ching Lin, Taipei City (TW); Hsien-Chang Wu, Taipei City (TW); Hung-Sung Hsu, Taipei City (TW)

(21) Appl. No.: 14/328,716

(22) Filed: Jul. 11, 2014

(51) Int. Cl. A63B 45/00; B32B 37/12; B32B 38/00; B32B 37/18

(52) U.S. Cl. CPC A63B 45/00; B32B 37/18; B32B 37/1284; B32B 38/0036; B32B 2038/008

(57) ABSTRACT

A manufacturing method for baseball and softball includes the steps of: providing a ball core, a first ball shell, and a second ball shell, and each of the first and second ball shells being substantially in an 8-shape and having a surface and an attaching surface; sewing stitches at the periphery of the first ball shell and the periphery of the second ball shell to form a first sewing portion and a second sewing portion respectively; coating an adhesive at the ball core and coating the adhesive on the attaching surfaces of the first ball shell and the second ball shell; heating the adhesive; and positioning and attaching the first ball shell and the second ball shell on a surface of the ball core, such that the stitches of the first sewing portion and the stitches of the second sewing portion are arranged symmetrically.

### BACKGROUND OF THE INVENTION

1. Field of the Invention

The present invention relates to a manufacturing method for balls, and more particularly the manufacturing method for baseballs and softballs.

2. Description of the Related Art

With the advancement of science and technology and the improvement of manufacturing processes, many products are manufactured by automated manufacturing methods, but there are still many products manufactured by semi-mechanical methods together with a manual method, and one of the examples is the manufacture of baseballs and softballs.

In the conventional baseball and softball manufacturing technology, a semi-automated manufacturing method is used for the manufacture and the attachment of the ball core with the ball shell and stitching stages are completed manually, and thus the manufacture requires operators of a higher level of technical skill, takes a longer manufacturing time and incurs a higher production cost, and it is difficult to control the quality of the produced baseballs and softballs.

In addition, there is a baseball/softball structure having a ball shell integrally wrapped around the whole ball core, and a mold for making the ball shell is used for forming stitches like hand-made stitches. Although this method can be used for the mass production of the product by automated manufacture, yet the ball shell is made of polyurethane (PU), so that the elasticity coefficient of such baseball and softball has a discrepancy with respect to conventional ones, and the hand feel of the grip of these balls is not as good as that of the conventional ones since the stitches are made of PU instead of a real thread. Therefore, it is an important issue for related manufacturers to improve the conventional manufacturing method for baseball and softball.

### SUMMARY OF THE INVENTION

In view of the problems of the prior art, it is a primary objective of the present invention to provide a manufacturing method for baseball and softball capable of reducing the labor significantly and using an automated production method to lower the cost, so as to improve the production capacity of the baseball and softball, while providing the hand feel of the grip of the baseball and softball which are manufactured by the conventional handmade sewing method.

To achieve the aforementioned objective, the present invention provides a manufacturing method for baseball and softball, comprising the following steps:

S1: Provide a ball core, a first ball shell and a second ball shell, wherein each of the first ball shell and the second ball shell is substantially in an 8-shape and has a surface and an attaching surface.

S2: Sew a plurality of stitches at the periphery of the first ball shell and the periphery of the second ball shell to form a first sewing portion and a second sewing portion respectively.

S3: Coat an adhesive at the ball core and coat the adhesive on the attaching surfaces of the first ball shell and the second ball shell.

S4: Heat the adhesive.

S5: Position and attach the first ball shell and the second ball shell on a surface of the ball core, such that the stitches of the first sewing portion and the stitches of the second sewing portion are arranged symmetrically.

In a preferred embodiment of the manufacturing method for baseball and softball, the ball core has at least one positioning groove formed thereon and provided for positioning and attaching the first ball shell and the second ball shell.

In a preferred embodiment of the manufacturing method for baseball and softball, the positioning groove is corresponsive to the first sewing portion of the attaching surface and the stitches of the second sewing portion.

In a preferred embodiment of the manufacturing method for baseball and softball, the attaching surface has a reinforcing pad attached thereon and configured to be corresponsive to the stitch boundary.

In a preferred embodiment of the manufacturing method for baseball and softball, the reinforcing pad has a thickness corresponsive to the height of the stitches of the first sewing portion and the second sewing portion of the attaching surface.

In a preferred embodiment of the manufacturing method for baseball and softball, the heating temperature falls within a range of 50˜90° C. in the step of heating the adhesive on the ball core and the ball shell.

In a preferred embodiment of the manufacturing method for baseball and softball, the stitches of the first sewing portion and the second sewing portion are arranged symmetrically in a V-shape in the steps of positioning and attaching the first ball shell and the second ball shell on the surface of the ball core such that the stitches of the first sewing portion and the second sewing portion are arranged symmetrically.

The manufacturing method for baseball and softball in accordance with of the present invention is capable of reducing the labor significantly and using an automated production method to lower the cost, so as to improve the production capacity of the baseball and softball, while providing the hand feel of the grip of the baseball and softball which are manufactured by the conventional handmade sewing method.

The aforementioned and other objectives, technical characteristics and advantages of the present invention will become apparent with the detailed description of preferred embodiments and the illustration of related drawings as follows.

### BRIEF DESCRIPTION OF THE DRAWINGS

FIG. 1 is a flow chart of a manufacturing method for baseball and softball of the present invention;

FIG. 2 is a schematic view of a ball core, a first ball shell, and a second ball shell of the present invention;

FIG. 3 is a schematic view of a first sewing portion and a second sewing portion surface of the present invention;

FIG. 4 is a schematic view of an attaching surface of a first sewing portion and a second sewing portion of the present invention;

FIG. 5 is a schematic view of an attaching surface of a first sewing portion and a second sewing portion including a reinforcing pad of the present invention;

FIG. 6 is a schematic view of positioning and attaching a ball core, a first ball shell and a second ball shell of the present invention; and

FIG. 7 is a schematic view of a baseball/softball after a ball core, a first ball shell, and a second ball shell are attached in accordance with the present invention.

### DETAILED DESCRIPTION OF THE PREFERRED EMBODIMENTS

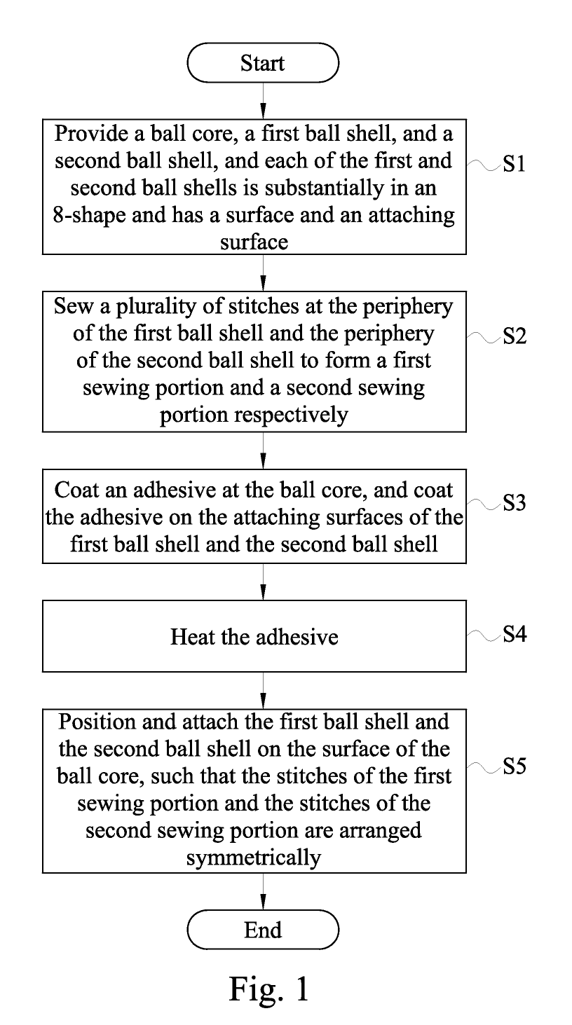

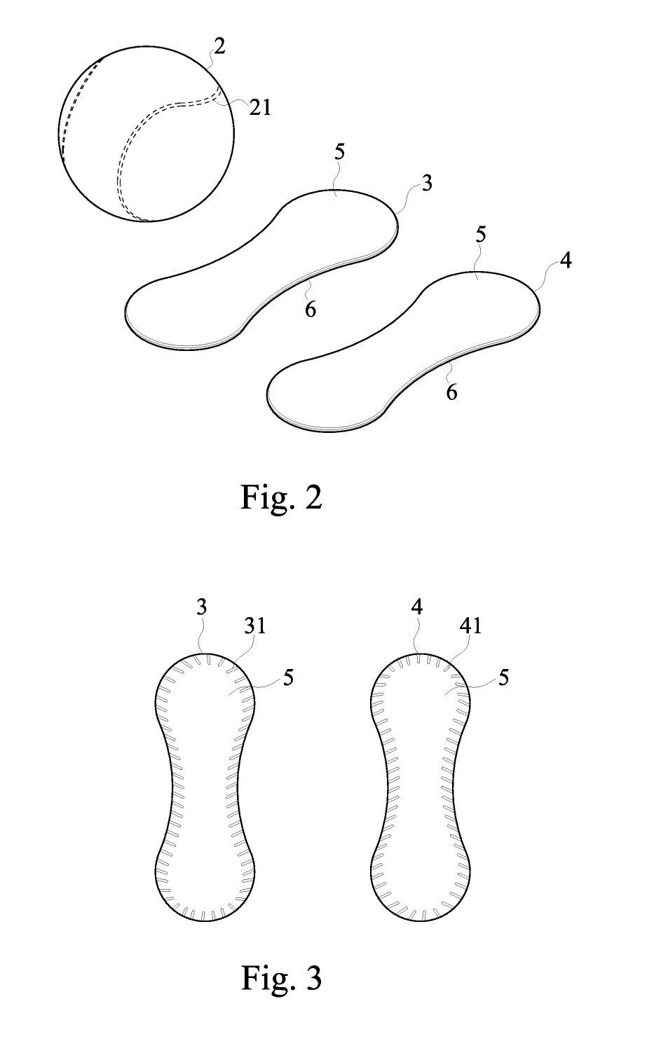

With reference to FIGS. 1 and 2 for a flow chart of a manufacturing method for baseball and softball and a schematic view of a ball core, a first ball shell and a second ball shell in accordance with the present invention, the manufacturing method for baseball and softball comprises the following steps:

S1: Provide a ball core 2, a first ball shell 3 and a second ball shell 4, wherein each of the first ball shell 3 and the second ball shell 4 is substantially in an 8-shape and has a surface 5 and an attaching surface 6.

S2: Sew a plurality of stitches at the periphery of the first ball shell 3 and the periphery of the second ball shell 4 to form a first sewing portion 31 and a second sewing portion 41 respectively (as shown in FIGS. 1 and 3).

S3: Coat an adhesive at the ball core and coat the adhesive on the attaching surfaces of the first ball shell and the second ball shell. In the method for forming the first sewing portion 31 and the second sewing portion 41, a conventional lasting machine is used for sewing, so that the stitches are formed obliquely on the surfaces 5 of the first ball shell 3 and the second ball shell 4 and arranged into a V-shape on the attaching surface 6, and the sewing directions of the first sewing portion 31 and the second sewing portion 41 are opposite to each other.

In the step S3 as shown in FIG. 1, the adhesive is coated at the ball core 2 and on the attaching surface 6 of the first ball shell 3 and the attaching surface 6 of the second ball shell 4, and the adhesive used in this step is a high-strength adhesive.

Wherein, the ball core 2 is put into a bucket filled with the adhesive and then stirred uniformly, so that the ball core 2 is passed through a tapered opening to scrape away extra adhesive from the ball core 2, and the attaching surface 6 of the first ball shell 3 and the attaching surface 6 of the second ball shell 4 are coated with the adhesive by a conventional soft-roller gluing machine.

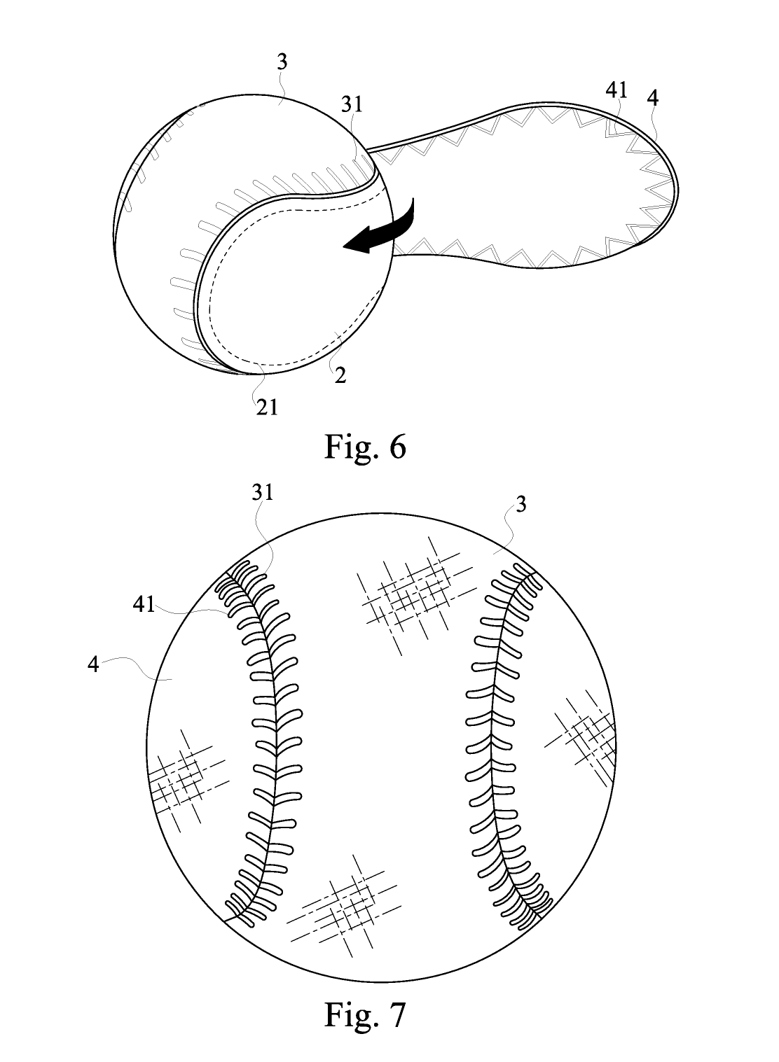

S4: Heat the adhesive. In the step S4 as shown in FIGS. 1 and 6, the adhesive at the ball core 2 and on the first ball shell 3 and the second ball shell 4 are heated.

In the step S5, the first ball shell 3 and the second ball shell 4 are positioned and attached onto a surface of the ball core 2, and the stitches of the first sewing portion 31 and the stitches of the second sewing portion 41 are arranged symmetrically.

S5: Position and attach the first ball shell and the second ball shell on a surface of the ball core, such that the stitches of the first sewing portion and the stitches of the second sewing portion are arranged symmetrically.

In the step S5 of another preferred embodiment as shown in FIG. 1, the first ball shell 3 and the second ball shell 4 are positioned and attached onto a surface of the ball core 2, and the stitches of the first sewing portion 31 and the stitches of the second sewing portion 41 are arranged symmetrically, wherein the ball core 2 is fixed by a positioning fixture. When the ball core 2 is fixed onto the positioning fixture, the first ball shell 3 is attached onto a laminating fixture, and then the laminating fixture attaches the first and second ball shells to the ball core 2, so that the first ball shell 3 is adhered with a surface of the ball core 2. Similarly, the second ball shell 4 is attached onto a surface of the ball core 2 by using the same method.

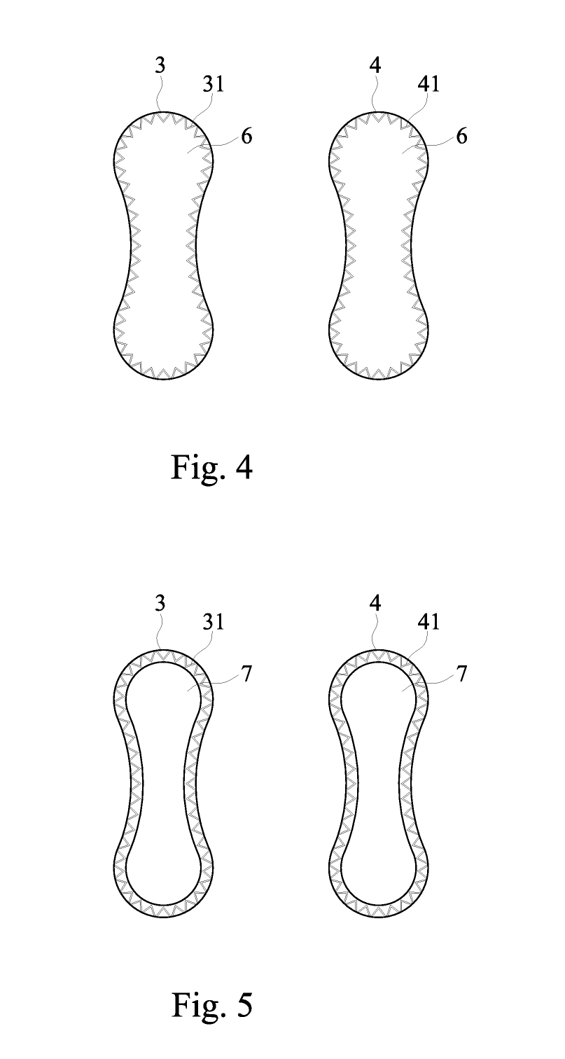

In another preferred embodiment as shown in FIGS. 2 and 4, the ball core 2 has at least one positioning groove 21 formed thereon and provided for positioning and attaching the first ball shell 3 and the second ball shell 4, wherein the positioning groove 21 is corresponsive to the stitches of the first sewing portion 31 and the stitches of the second sewing portion 41 of the attaching surface 6.

In another preferred embodiment as shown in FIG. 5, a reinforcing pad 7 is attached onto the attaching surface 6 and configured to be corresponsive to the stitch boundary. Wherein, the thickness of the reinforcing pad 7 is corresponsive to the height of the first sewing portion 31 and the second sewing portion 42 of the attaching surface 6.

In the step S4 of another preferred embodiment as shown in FIG. 1, the heating temperature falls within a range of 50-90° C. and the heating time falls within a range of 2-10 minutes in the step of heating the adhesives at the ball core 2 and on the first ball shell 3 and the second ball shell 4.

In the step S5 of another preferred embodiment as shown in FIGS. 1 and 7, the stitches of the first sewing portion 31 and the stitches of the second sewing portion 41 are arranged symmetrically in a V-shape in the step of positioning and fixing the first ball shell 3 and the second ball shell 4 onto a surface of the ball core 2, and arranging the stitches of the first sewing portion 31 and the stitches of the second sewing portion 41 symmetrically.

The manufacturing method for baseball and softball in accordance with the present invention is capable of reducing the labor significantly and using an automated production method to lower the cost, so as to improve the production capacity of the baseball and softball, while providing the hand feel of the grip of the baseball and softball which are manufactured by the conventional handmade sewing method.

What is claimed is:

1. A manufacturing method for baseball and softball, comprising the steps of:
providing a ball core, a first ball shell, and a second ball shell, and each of the first and second ball shells being substantially in an 8-shape and having a surface and an attaching surface;
sewing a plurality of stitches at the periphery of the first ball shell and the periphery of the second ball shell to form a first sewing portion and a second sewing portion respectively;
coating an adhesive at the ball core, and coating the adhesive on the attaching surfaces of the first ball shell and the second ball shell;
heating the adhesive; and
positioning and attaching the first ball shell and the second ball shell on a surface of the ball core, such that the stitches of the first sewing portion and the stitches of the second sewing portion are arranged symmetrically.

2. The manufacturing method for baseball and softball according to claim 1, wherein the ball core has at least one positioning groove formed thereon and provided for positioning and attaching the first ball shell and the second ball shell.

3. The manufacturing method for baseball and softball according to claim 2, wherein the positioning groove is corresponsive to the first sewing portion of the attaching surface and the stitches of the second sewing portion.

4. The manufacturing method for baseball and softball according to claim 1, wherein the attaching surface has a reinforcing pad attached thereon and configured to be corresponsive to the stitch boundary.

5. The manufacturing method for baseball and softball according to claim 4, wherein the reinforcing pad has a thickness corresponsive to the height of the stitches of the first sewing portion and the second sewing portion of the attaching surface.

6. The manufacturing method for baseball and softball according to claim 1, wherein the heating temperature falls within a range of 50-90° C. in the step of heating the adhesive on the ball core and the ball shell.

7. The manufacturing method for baseball and softball according to claim 1, wherein the stitches of the first sewing portion and the stitches of the second sewing portion are arranged symmetrically in a V-shape in the steps of positioning and attaching the first ball shell and the second ball shell on the surface of the ball core such that the stitches of the first sewing portion and the stitches of the second sewing portion are arranged symmetrically.
